(19) United States
(12) Patent Application Publication
(10) Pub. No.: US 2026/0073137 A1
(43) Pub. Date: Mar. 12, 2026

(54) AI-BASED PREDICATE GENERATION IN MOBILE DEVICE MANAGEMENT NETWORKS

(71) Applicant: Ivanti, Inc., South Jordan, UT (US)

(72) Inventors: Silpa Pitchapati, Bangalore (IN); Yosune Baltra, San Jose, CA (US); Monu Agrawal, Bangalore (IN); Sachin Kumar Ishwar, Bangalore (IN)

(73) Assignee: Ivanti, Inc., South Jordan, UT (US)

(21) Appl. No.: 19/076,367

(22) Filed: Mar. 11, 2025

(30) Foreign Application Priority Data
Sep. 12, 2024 (IN) 202411069007

(51) Int. Cl. G06F 40/274; G06F 40/166; G06F 40/253

(52) U.S. Cl. CPC G06F 40/274; G06F 40/166; G06F 40/253

(57) ABSTRACT

An embodiment includes a method of artificial intelligence (AI)-based predicate generation in a mobile device management (MDM) network implementing declarative device management (DDM). The method includes receiving an input to identify one or more managed devices of the MDM network, displaying an MDM predicate user interface with an activation field, and receiving user input in the activation field that describes a desired MDM configuration at the identified managed devices. The user input includes a natural language description, which is provided to a custom AI model trained on supported attributes of a DDM system. The AI model broadly interprets the natural language description to associate it with a predicate that best reflects the desired MDM configuration and parameters of the identified managed devices. The method returns the predicate that implements the desired MDM configuration at the identified managed devices and causes distribution of an approved predicate to the identified managed devices.

### CROSS REFERENCE TO RELATED APPLICATION

This application claims priority to and the benefit of Indian Provisional Patent Application No.: 202411069007 filed Sep. 12, 2024, which is incorporated herein by reference in its entirety.

### FIELD

The present disclosure relates to mobile device management (MDM) networks, and more particularly to systems and methods of artificial intelligence (AI)-based predicate generation in MDM networks implementing declarative device management (DDM).

### BACKGROUND

Mobile device management (MDM) systems are implemented in managed networks to enable control of managed devices. MDM systems may enable a centralized or administrative device to determine configurations of the managed devices such as security settings, application management, etc. MDM systems are implemented to ensure the managed devices adhere to rules of managed network that protect enterprise resources, prevent introduction of vulnerabilities, and ensure adherence to corporate policies.

Apple released declarative device management (DDM) that allows devices to apply configurations independently. DDM is an update to the existing protocol for device management that can be used in combination with the existing MDM protocol capabilities. It allows the device to asynchronously apply settings and report status back to the MDM system without constant polling. DDM is based on criteria that are defined using predicates.

The predicate is a logic expression that can be added to a DDM configuration to instruct a device the conditions needed for the configuration to be activated. The predicates can be based on admin-defined properties that enable device configurations to be applied without having to communicate directly with an MDM server. However, the use of predicates can introduce difficulties in MDM systems, such as the need for ongoing maintenance by MDM administrators to keep up with updates to the predicates released and supported by Apple. The predicates include instructions that are sent to Apple devices, where the predicates are applied and implemented.

The predicates introduce difficulties in MDM systems. For instance, the predicates adhere to Cocoa™ language syntax, which is difficult to understand. Additionally, the predicates released and supported by Apple are regularly updated, which introduces an ongoing maintenance expenditure by admins. The difficulties of predicates may result in inefficient or erroneous predicates, which may enable managed devices to be improperly configured that may result in persistent vulnerabilities, use of unauthorized applications, etc.

Accordingly, there is a need in the field of MDM systems that enables the generation and distribution of predicates to managed devices. The subject matter claimed herein is not limited to embodiments that solve any disadvantages or that operate only in environments such as those described. Rather, this background is only provided to illustrate one example technology area where some embodiments described herein may be practiced.

### SUMMARY

According to an aspect of the invention, an embodiment includes a method of artificial intelligence (AI)-based predicate generation in a mobile device management (MDM) network implementing declarative device management (DDM). The method may include receiving an input to identify one or more managed devices of the MDM network. The one or more managed devices may include Apple™ devices. The method may include displaying an MDM predicate user interface (hereinafter, “predicate UX”) with an activation field. The method may include receiving user input in the activation field that describes a desired MDM configuration at the identified managed devices. The method includes providing the user input to a custom AI model. The custom AI model may be trained on supported attributes of a DDM system. The custom AI model may be configured to interpret the natural language description to associate it with a predicate that best reflects the desired MDM configuration and parameters of the identified managed devices. The custom AI model may also be configured to broadly interpret an operator or a code fragment included in the user input and to correct a mistake in the user input prior to the association between the natural language of the user input and the predicate. The custom AI model may also be configured to return an error message if no predicate reflects the desired MDM configuration. The method may include returning the predicate that implements the desired MDM configuration at the identified managed devices. The predicate may be formatted according to Cocoa™. The predicate may be returned in a second field of the predicate UX in code text. The method may include receiving an edit to the code text in the second field to generate an edited predicate. The method may also include collecting analytics data related to the edited predicate, analyzing discrepancies between the edited predicate and the returned predicate, and modifying the custom AI model based on the analyzed discrepancies. The method may also include receiving a confirmation input at the predicate UX. The method may include receiving an indication that the returned predicate is rejected. Responsive to rejection of the returned predicate, the method may include collecting analytics data related to the rejected predicate and modifying the custom AI model. After the custom AI model is modified, the method may include receiving modified user input that describes a modified desired MDM configuration, providing the modified user input to the custom AI model, and returning a modified predicate that implements the modified desired MDM configuration at the identified managed devices. The method may include causing distribution of an approved predicate to the identified managed devices. The method may include modifying the custom AI model with updated supported attributes.

An additional aspect of an embodiment includes a non-transitory computer-readable medium having encoded therein programming code executable by one or more processors to perform or control performance at least a portion of the method described above.

Yet another aspect of an embodiment includes a computer device. The computer device may include one or more processors and a non-transitory computer-readable medium. The non-transitory computer-readable medium has encoded therein programming code executable by the one or more processors to perform or control performance of one or more of the operations of the methods described above.

The object and advantages of the embodiments will be realized and achieved at least by the elements, features, and combinations particularly pointed out in the claims. It is to be understood that both the foregoing general description and the following detailed description are exemplary and explanatory and are not restrictive of the invention, as claimed.

### BRIEF DESCRIPTION OF THE DRAWINGS

Example embodiments will be described and explained with additional specificity and detail through the use of the accompanying drawings in which:

FIG. 1 depicts a block diagram of an example operating environment in which some embodiments of the present disclosure may be implemented;

FIG. 2 is a block diagram of artificial intelligence (AI)-based predicate generation process (process) that may be implemented in the operating environment of FIG. 1;

FIG. 3 is a block diagram of an example MDM admin user interface that may be implemented in the process of FIG. 2;

FIG. 4 is a block diagram of an example MDM predicate user interface that may be implemented in the process of FIG. 2;

FIG. 5 illustrates an example computer system configured AI-based predicate generation in a managed network; and

FIGS. 6A and 6B are a flow chart of an example method of AI-based predicate generation,

all according to at least one embodiment described in the present disclosure.

### DESCRIPTION OF SOME EXAMPLE EMBODIMENTS

The embodiments described in this disclosure are related mobile device management (MDM) networks. Some embodiments are directed to systems and methods of artificial intelligence (AI)-based predicate generation in the MDM networks implementing declarative device management (DDM). For instance, in some embodiments one or more managed devices of a managed network are identified. These identified managed devices are the devices that receive an approved predicate. User input is also received describing a desired MDM configuration at the identified managed devices. The user input includes a natural language description which is provided to a custom AI model, which is trained on supported attributes of a DDM system. The custom AI model is configured to broadly interpret the natural language description to associate the natural language of the user input with a predicate that best reflects the desired MDM configuration and parameters of the identified managed devices. The custom AI model generates and returns a predicate that implements the desired MDM configuration at the identified managed devices as described in the user input. The predicate may then be confirmed, rejected, or edited. The predicate or an edited predicate is then distributed to the identified managed devices for implementation at the managed devices.

These and other embodiments are described with reference to the appended Figures in which like item number indicates like function and structure unless described otherwise. The configurations of the present systems and methods, as generally described and illustrated in the Figures herein, may be arranged and designed in different configurations. Thus, the following detailed description of the Figures, is not intended to limit the scope of the systems and methods, as claimed, but is merely representative of example configurations of the systems and methods.

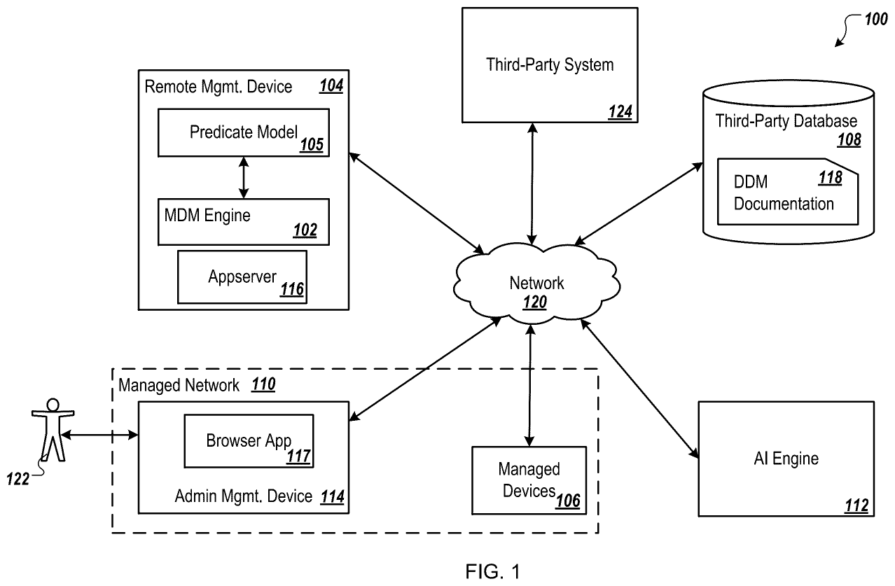

FIG. 1 is a block diagram of an example operating environment 100 in which some examples of the present disclosure can be implemented. The operating environment 100 may be configured for AI-based predicate generation by an MDM engine 102. The predicate may then be distributed to the managed devices 106 of a managed network 110. The generation of the predicate is based on a predicate model 105 and an AI engine 112. The MDM engine 102 generates the predicate based on natural language input by an administrator 122 into an appserver 116 (e.g., via a browser application “browser app 117”) that describes an MDM device configuration desired at one or more of the managed devices 106. The predicate model 105 and the AI engine 112 are used to broadly interpret the natural language input to and to associate the natural language input with a predicate that best implements the desired device configuration.

In the operating environment 100, the MDM engine 102 implements declarative device management (DDM) to manage at least a portion of the managed devices 106. Specifically, in some embodiments, the portion of the managed devices 106 managed using the DDM may be Apple™ or Mac™ computing systems or may implement Apple™ or Mac™ operating systems such as iOS, MacOS, etc.

Conventional MDM systems implementing DDM use the predicates. However, in these conventional MDM systems generally rely on admins or information technology (IT) personnel to draft the predicates. However, the predicates are difficult to draft because the predicates are written in a specific coding language, namely Cocoa™, and the DDM framework is modified and updated. Accordingly, drafting the predicates manually is error prone and may not incorporate updated or the latest DDM attributes. Accordingly, these conventional MDM systems may suffer from delayed and erroneously drafted predicates, which result in the introduction of security issues such as unauthorized access, installation of unauthorized applications, etc. at the managed devices 106.

Embodiments of the present disclosure provide a technical improvement to conventional MDM systems. Specifically, embodiments of the present disclosure use a custom AI model, which is represented in FIG. 1 by the predicate model 105 combined with the AI engine 112. The custom AI model is trained on supported attributes of a DDM system, which are represented in FIG. 1 by the DDM documentation 118, along with sample user input and sample predicates. The custom AI model may be configured to interpret the user input entered in natural language and to associate it with a predicate that best reflects the desired MDM configuration. The custom AI model has access to parameters of the managed devices 106 and can customize the predicate to direct it to the managed devices 106. Accordingly, the predicates used in the operating environment 100 may be generated based on natural language input, which reduces or eliminates a need of the administrator 122 to know syntax, formatting, etc. of the predicates. Additionally, as the DDM documentation 118 is updated, the custom AI model is updated. Accordingly, the predicates generated in the operating environment 100 may be based on the latest versions of the DDM system.

Accordingly, examples of the present disclosure are directed to a computer-centric problem and are implemented in a computer-centric environment. For instance, the examples of the present disclosure are directed to MDM systems in the managed network 110. Computing processes occurring in the operating environment 100 include communication and implementation of user input, the AI engine 112, and distribution of predicates at the managed devices 106. Communications during the processes described in this present disclosure involve the communication of data in electronic and optical forms via a network 120 and also involve the electrical and optical interpretation of the data and information.

The operating environment 100 may include the managed network 110, a third-party system 124, a third-party database 108, a remote management device 104, and the AI engine 112. The managed network 110 may include an admin management device 114 and the managed devices 106. The components of the operating environment 100 are configured to communicate data and information via the network 120 to perform generation and implementation of predicates as described in the present disclosure. Each of these components are introduced below.

The network 120 may include any communication network configured for communication of signals between the components (e.g., 104, 112, 108, 114, and 106) of the operating environment 100. The network 120 may be wired or wireless. The network 120 may have configurations including a star configuration, a token ring configuration, or another suitable configuration. Furthermore, the network 120 may include a local area network (LAN), a wide area network (WAN) (e.g., the Internet), and/or other interconnected data paths across which multiple devices may communicate. In some examples, the network 120 may include a peer-to-peer network. The network 120 may also be coupled to or include portions of a telecommunications network that may enable communication of data in a variety of different communication protocols.

In some examples, the network 120 includes or is configured to include a BLUETOOTH® communication network, a Z-Wave® communication network, an Insteon® communication network, an EnOcean® communication network, a Wi-Fi communication network, a ZigBee communication network, a representative state transfer application protocol interface (REST API) communication network, an extensible messaging and presence protocol (XMPP) communication network, a cellular communications network, any similar communication networks, or any combination thereof for sending and receiving data. The data communicated in the network 120 may include data communicated via short messaging service (SMS), multimedia messaging service (MMS), hypertext transfer protocol (HTTP), direct data connection, wireless application protocol (WAP), or any other protocol that may be implemented in the components of the operating environment 100.

The depicted example of the operating environment 100 includes the third-party system 124. The third-party system 124 may include a hardware-based server configured to communicate data and information with the other components of the operating environment 100 via the network 120. The third-party system 124 may be configured to support distribution of the predicates in the operating environment 100. For instance, after a predicate is generated and approved by the administrator 122, the predicate may be distributed to the managed devices 106 based on operations performed by or established by the third-party system 124. The MDM engine 102 may cause distribution of the predicate via the third-party system and operations built by the third-party system. For instance, in some embodiments, the third-party system 124 may include an Apple server that is associated with Apple. The MDM engine 102 may be used to generate a predicate to be implemented at the managed devices 106. The MDM engine 102 may receive confirmation from the admin regarding the predicate. Responsive to the confirmation, the MDM engine 102 causes distribution via an Apple operating system and/or hardware components.

The third-party system 124 may also communicate with the third-party database 108. For instance, the third-party system 124 may update available predicates, predicate types, syntax, keys, etc. The third-party system 124 may communicate DDM documentation 118 reflecting the updates to the third-party database 108. The DDM documentation 118 may be stored at the third-party database 108. The DDM documentation 118 it may be accessible to the remote management device 104 to update the custom AI model. The third-party database 108 may include a non-transitory storage medium such as the memory 512 that is configured to communicate with one or more of the components of the operating environment 100 via the network 120. In some embodiments, the third-party database 108 may be incorporated in the third-party system 124.

The managed network 110 includes the admin management device 114 and the managed devices 106. The managed network 110 is implemented to enable management of the managed devices 106 by the remote management device 104. To implement the managed network 110, the managed devices 106 and the admin management device 114 may be enrolled. After the managed devices 106 and the admin management device 114 are enrolled, ongoing management of the managed devices 106 may be implemented by the remote management device 104 and the admin management device 114. The ongoing management may include overseeing and dictating at least a part of the operations at the managed devices 106 as well as dictate or control policies such as application policies, security policies, communication policies, etc. at the managed devices 106 as described in the present disclosure. The managed network 110 may be associated with an enterprise, a portion of an enterprise, a government entity, or another entity or set of devices. The managed network 110 may be an MDM network in which the managed devices 106 are managed.

The managed devices 106 may include hardware-based computer systems that are configured to communicate with the other components of the operating environment 100 via the network 120. The managed devices 106 may include any computer device that may be managed by the remote management device 104 and/or have been enrolled in the managed network 110. Generally, the managed devices 106 include devices that are operated by the personnel and systems of an enterprise or store and process data of the enterprise. The managed devices 106 might include workstations of an enterprise, servers, data storage systems, printers, telephones, internet of things (IOT) devices, smart watches, sensors, automobiles, battery charging devices, scanner devices, etc. The managed devices 106 may also include virtual machines, which may include a portion of a single processing unit or one or more portions of multiple processing units, which may be included in multiple machines.

The admin management device 114 may include a hardware-based computer system that is configured to communicate with the other components of the operating environment 100 via the network 120. The admin management device 114 is configured to at least partially administrate MDM in the managed network 110. For example, the admin management device 114 may include a browser app 117 that interfaces with an application server interface (in the present disclosure, “appserver”) 116. The browser app 117 accesses the appserver 116 of the MDM engine 102 via the network 120. The appserver 116 hosts user interfaces and webpages of the remote management device 104. The user interfaces and webpages may be displayed at the admin management device 114. Input received via the browser app and the appserver 116 117 may be communicated to the MDM engine 102.

The admin management device 114 may be associated with the administrator 122. The administrator 122 may be an individual, a set of individuals, or a system that interfaces with the admin management device 114. In some examples, the administrator 122 may provide input to the admin management device 114. The input provided by the administrator 122 may form the basis of some computing processes performed by the admin management device 114 and the MDM engine 102. For example, the administrator 122 may provide user input to the appserver 116 via the browser app 117, which is used as input to the MDM engine 102. In some embodiments, the user input may include a natural language input entered in text or audibly. The user input may include text, code fragments, operators, etc. In addition, the user input may include mistakes. The user input is communicated from the appserver 116 to the MDM engine 102 and the predicate model 105. Based on the user input, the predicate may be generated. Additionally, after the predicate is generated, it may be returned to the appserver 116 such that it may be reviewed by the administrator 122 using the browser app 117. In some embodiments, the administrator 122 may confirm, reject, or edit the returned predicate prior to distribution to the managed devices 106.

In some embodiments, the admin management device 114 may include the MDM engine 102 and the predicate model 105. In these and other embodiments, the predicate generation and the MDM may be performed as an “on prem” service. In these embodiments, the remote management device 104 may be omitted or may not implement processes and operations related to generation and implementation of the predicates. Instead, the admin management device 114 may implement these processes and operations.

In some embodiments, the admin management device 114 is one of or substantially similar to the managed devices 106. For instance, the admin management device 114 may be one of the managed devices 106 assigned to the administrator 122. Additionally, in some embodiments, the admin management device 114 may be omitted, and the administrator 122 may use one of the managed devices 106 to interface with the remote management device 104 remotely.

The remote management device 104 may include a hardware-based computer system that is configured to communicate with the other components of the operating environment 100 via the network 120. In some examples, the remote management device 104 may be a single server, a set of servers, a virtual device, or a virtual server in a cloud-base network of servers. In these and other examples, the MDM engine 102, the appserver 116, and the predicate model 105 may be spread over two or more cores, which may be virtualized across multiple physical machines.

The remote management device 104 may be configured for mobile device management (MDM) of the managed devices 106 in the managed network 110. In general, MDM of the managed devices 106 may include determining security polices, application policies, the security settings, network communication settings, etc. implemented at the managed devices 106. In some embodiments, the remote management device 104 may be configured to supply other management services unified endpoint management, service management (e.g., help desk and technical ticketing), patch or update management, application management, asset management, vulnerability detection, other management services, or combinations thereof.

The remote management device 104 may include the MDM engine 102 and the predicate model 105. The MDM engine 102 may be configured for AI-based predicate generation. The MDM engine 102 is implemented to generate the predicates in the managed network 110 that at least partially implements DDM. The MDM engine 102 may be configured to host one or more webpages or user interface applications that enable the administrator 122 to interface with the MDM engine 102. For instance, the MDM engine 102 may host an MDM admin user interface (hereinafter, “MDM admin UX”) that enables the administrator 122 to identify one or more of the managed devices 106. Identification of the managed devices 106 may represent a selection of the identified managed devices 106 to which the predicate may be distributed. An example of the MDM admin UX is described elsewhere in the present disclosure. To begin to generate the predicate, the MDM engine 102 may be configured to receive an input sufficient to identify one or more of the managed devices 106. For instance, the administrator 122 may use the browser app 117 of the admin management device 114 to select the MDM admin UX hosted by the appserver 116.

The MDM engine 102 or the appserver 116 may also cause display of an MDM predicate user interface (hereinafter, “predicate UX”). For instance, the MDM engine 102 or the appserver 116 may cause display of the predicate UX at the browser app 117. The predicate UX may include an activation field. In the activation field, the administrator 122 may provide user input that describes a desired MDM configuration to be implemented at the identified managed devices 106. The user input may include a natural language description. Additionally, the user input may include operators (e.g., =, +, −, &&, /=, etc.), code fragments (e.g., JSON code text, etc.), as well as text.

The MDM engine 102 may provide the user input to a custom AI model. The custom AI model may include the predicate model 105 and the AI engine 112. The AI engine 112 may include a large language model (LLM) AI program that comprehends the user input and generates the predicate. Some examples of the AI engine 112 may include GPT™ by OpenAI™, Gemini ™ by Google™, LLaMA™ by Meta™, and the like. The AI engine 112 interfaces with the predicate model 105 that leverages the AI engine 112. The predicate model 105 and the AI engine 112 are trained on supported attributes of a DDM system, which may be found at least partially in the DDM documentation 118. In some embodiments, the predicate model 105 and the AI engine 112 may be trained using sample predicates and sample user input. The supported attributes may include predicate language and syntax, DDM statuses, DDM status objects, DDM status object syntax, declarations, DDM keys, other attributes, or combinations thereof.

The custom AI model is configured to broadly interpret the natural language description to associate the natural language of the user input with a predicate that best reflects the desired MDM configuration and parameters of the identified managed devices. Accordingly, the custom AI model may generate a predicate that performs the function of the desired configuration and incorporates parameters of the identified managed devices 106 (that were previously selected).

The MDM engine 102 may return the predicate. The returned predicate may be formatted according to the Cocoa™ coding language. The predicate may be returned and displayed in a second field of the predicate UX and may be displayed in code text. After the predicate is returned, it may be approved, rejected, or edited. After the predicate is approved, the MDM engine 102 may cause distribution of the approved predicate to the identified managed devices 106.

In some embodiments, the MDM engine 102 and the predicate model 105 may be configured to analyze feedback such as edits and rejections of the returned predicates. In these and other circumstances, the MDM engine 102 may be configured to collect analytics data related to the edited or rejected predicate. The MDM engine 102 may then analyze discrepancies between the edited predicate and the returned predicate or data related to the rejected predicate. The MDM engine 102 may then modify the custom AI model. In addition, the MDM engine 102 may modify the custom AI model with updated supported attributes published by the third-party system 124 such as new DDM statuses or new DDM keys.

In the depicted embodiment, the AI engine 112 is separate from the predicate model 105. In other embodiments, the AI engine 112 and the predicate model 105 are integrated at the remote management device 104.

The appserver 116, the browser app 117, the predicate model 105, the MDM engine 102, the AI engine 112 and components thereof may be implemented using hardware including a processor, a microprocessor (e.g., to perform or control performance of one or more operations), a field-programmable gate array (FPGA), or an application-specific integrated circuit (ASIC). In some other instances, appserver 116, the browser app 117, the predicate model 105, the MDM engine 102, the AI engine 112, and components thereof may be implemented using a combination of hardware and software. Implementation in software may include rapid activation and deactivation of one or more transistors or transistor elements such as may be included in hardware of a computing system (e.g., the admin management device 114 or the remote management device 104 of FIG. 1). Additionally, software defined instructions may operate on information within transistor elements. Implementation of software instructions may at least temporarily reconfigure electronic pathways and transform computing hardware.

Modifications, additions, or omissions may be made to the operating environment 100 without departing from the scope of the present disclosure. For example, the operating environment 100 may include one or more managed networks 110, one or more remote management devices 104, one or more managed devices 106, one or more third-party systems 124, one or more admin management devices 114, or any combination thereof. Moreover, the separation of various components and devices in the examples described herein is not meant to indicate that the separation occurs in all examples. Moreover, it may be understood with the benefit of this disclosure that the described components and servers may generally be integrated together in a single component or server or separated into multiple components or servers.

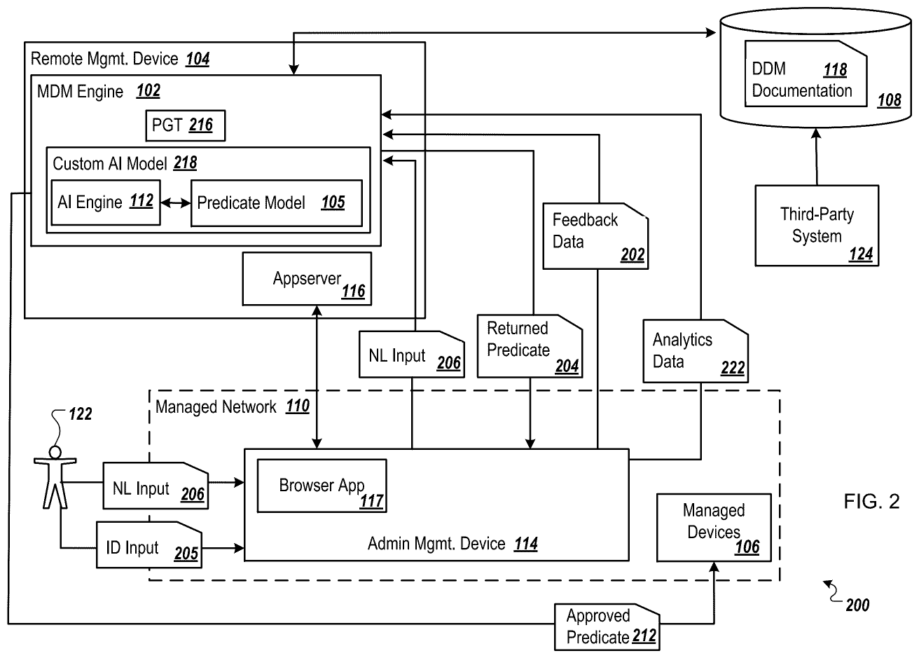

FIG. 2 is a block diagram of AI-based predicate generation process (process) 200 that may be implemented in the operating environment 100 of FIG. 1 or another suitable environment. FIG. 2 includes systems and components (e.g., 102, 104, 105, 106, 108, 114, 116, 117, 118, 122, 124, etc.) described with reference to FIG. 1. Although not depicted in FIG. 2, communication of data and information in FIG. 2 may be via a network such as the network 120 of FIG. 1.

The process 200 may be implemented to generate and distribute an approved predicate 212 to the managed devices 106 or a portion thereof of the managed network 110. As described with reference to FIG. 1, at least a portion of the managed devices 106 may be Apple or Mac devices. Accordingly, the managed network 110 may implement DDM relative to the portion of the managed devices 106 to provide MDM services. In the embodiment of FIG. 2, the approved predicate 212 may be derived by a predicate generation tool (“PGT”) 216 included in the MDM engine 102. The PGT 216 is implemented in with a custom AI model 218 that is trained to return a predicate (hereinafter, “returned predicate”) 204 based on natural language input (generally, NL input) 206 received from the administrator 122.

The process 200 may begin with the MDM engine 102 providing or causing display of an MDM admin UX. The MDM admin UX may provide MDM functionality to the administrator 122. One function that may be performed in the MDM admin UX is selection or identification of one or more of the managed devices 106 to which the approved predicate 212 is distributed. In some embodiments, the MDM admin UX may enable selection by the administrator 122 of one of the managed devices 106 or of multiple managed devices 106. Selection of multiple managed devices 106 may be based on a common feature of the managed devices 106 or subsets of the managed devices 106 may be grouped and a group may be selected.

The administrator 122 may provide identification input (in FIG. 2, “ID input”) 205. For instance, the administrator 122 may press a button in the MDM admin UX, check a box, or type in the names or identifiers of the managed devices 106 to identify the managed devices 106 to which the approved predicate 212 is distributed. The MDM engine 102 and the PGT 216 may receive the ID input 205. For instance, the administrator 122 may provide the ID input 205 to the browser app 117, which communicates the ID input 205 to the appserver 116, which is communicated to the PGT 216.

The PGT 216 may cause display of a predicate UX. For instance, in the example above, the administrator 122 may select one or more of the managed devices 106. Responsive to the ID input 205, the PGT 216 may cause display of the predicate UX. Additionally or alternatively, the MDM admin UX may include a button that, when selected, triggers the PGT 216 to display of the predicate UX.

The predicate UX may include an activation field. The activation field may be configured to receive the NL input 206 from the administrator 122. The NL input 206 describes a desired MDM configuration to be implemented at the identified managed devices 106. The NL input 206 may include a natural language description, of a desired configuration of the identified managed devices 106. Additionally, the NL input 206 may include an operator, a code fragment, as well as natural language text or audio input. Additionally, the natural language description may include a mistake such as a misspelled word, a typographical error, or grammatical error.

After the NL input 206 is received, the PGT 216 may provide the NL input 206 to a custom AI model 218. As introduced elsewhere in the present disclosure, the custom AI model 218 is trained on supported attributes of the DDM system. For example, DDM documentation 118 may include examples of the supported attributes. The supported attributes may include predicate language and syntax, DDM statuses, DDM status objects, DDM status object syntax, declarations, DDM keys, sample predicates, sample user inputs, other supported attributes, or combinations thereof. The PGT 216 may obtain or access the DDM documentation 118 and use it as a basis to train the custom AI model 218. For instance, the DDM documentation 118 may be incorporated in the predicate model 105 and used to anticipate and infer relationships between the NL input 206 and possible predicates.

Based on the training, the custom AI model 218 may be configured to broadly interpret the NL input 206. Interpretation of the NL input 206 is implemented to associate the NL input 206 with a predicate available in the DDM system that best reflects the desired MDM configuration and that includes parameters of the identified managed devices 106 that enable implementation of the desired MDM configuration. The custom AI model 218 may also be configured to broadly interpret the operator or the code fragment and to correct the mistake prior to the association between the NL input 206 and the predicate. Additionally, in some embodiments, the custom AI model 218 may be further configured to return an error message if no predicate reflecting the desired MDM configuration and the parameters of the identified managed devices 106 is found.

The custom AI model 218 may return a predicate 204. The predicate 204 that is returned implements the desired MDM configuration the identified managed devices 106 that is described in the activation field. The predicate 204 may be formatted according to Cocoa™, or another suitable language used in a DDM system. The PGT 216 may communicate the returned predicate 204 to the appserver 116, which makes it available in the browser app 117 of the admin management device 114.

In some embodiments, The PGT 216 may return the predicate 204 in a second field of the predicate UX. The predicate 204 may be returned in the second field in code text, which enables inspection and review of the predicate 204. After the predicate 204 is returned, there are at least three possible actions prior to the distribution of the predicate 204.

A first possible action is that the returned predicate 204 is rejected. In these circumstances, feedback data 202 from the admin management device 114 may include an indication that that returned predicate 204 is rejected. For instance, the administrator 122 may review the returned predicate 204 and determine that the returned predicate 204 does not reflect the NL input 206 or is otherwise inoperable at the identified managed devices 106. Accordingly, the administrator 122 may select a button in the predicate UX indicating that the returned predicate 204 is rejected or cancelled. The feedback data 202 communicated to the PGT 216 includes the indication of the rejection. In response to the rejection of the returned predicate 204, the PGT 216 does not distribute the returned predicate 204 to the identified managed devices 106.

After the returned predicate 204 is rejected, modified user input may be received in the activation field. The modified user input may include NL input 206 in a different form or changed in some way by the administrator 122. The modified user input may describe a modified, desired MDM configuration or another attempt to describe the previously desired MDM configuration. The modified user input is provided to the custom AI model 218, a modified predicate (e.g., 204) is returned that implements the modified desired MDM configuration described in the activation field. The modified predicate may then be confirmed, edited, or rejected as described herein.

Additionally, in some embodiments, in response to the rejection of the returned predicate 204, the PGT 216 may collect analytics data 222. The analytics data 222 collected after the rejection may be related to the rejected, returned predicate. For instance, the analytics data 222 that are collected may be related to the NL input 206, the operations of the custom AI model 218, and the returned predicate 204. The custom AI model 218 may be modified based on the analytics data 222. For instance, the custom AI model 218 may be modified to change a future predicate returned based on the NL input 206. For example, the custom AI model 218 may modified such that a different predicate is returned in response to the NL input 206. In general, the PGT 216 may determine that the NL input 206 should not be associated with the returned predicate 204 and modify the custom AI model 218 to prevent this from happening.

A second possible action is that the returned predicate 204 is approved or confirmed. In these circumstances, the feedback data 202 from the admin management device 114 may include an indication that that returned predicate 204 is confirmed. For instance, the administrator 122 may review the returned predicate 204 and determine that the returned predicate 204 reflects the NL input 206 or is operable at the managed devices 106. Accordingly, the administrator 122 may select a button in the predicate UX indicating that the returned predicate 204 is confirmed. The feedback data 202 communicated to the custom AI model 218 includes the indication of the confirmation.

In response to the confirmation of the returned predicate 204, an approved predicate 212 that is substantially similar to the returned predicate 204 is communicated to the PGT 216. The PGT 216 distributes the approved predicate 212 to the identified managed devices 106. The approved predicate 212 includes the returned predicate 204 displayed in the predicate UX when the confirmation input is received.

A third possible action is that the returned predicate 204 is edited. In these circumstances, the feedback data 202 from the admin management device 114 may include an indication that that returned predicate 204 is edited. For instance, the administrator 122 may review the returned predicate 204 and determine that the returned predicate 204 does not reflect the NL input 206 or is inoperable at the managed devices 106. Accordingly, the administrator 122 may edit the returned predicate 204 through typing or otherwise entering edits to code text displayed in the predicate UX. In embodiments in which the returned predicate 204 is displayed as code text in the second field, the edits may be received in the second field.

The feedback data 202 communicated to the custom AI model 218 may include the indication that the returned predicate 204 is edited and/or an edited predicate. For instance. the edit(s) may be incorporated into the returned predicate 204 to generate the edited predicate. The edited predicate may become the approved predicate 212, which is communicated to the PGT 216. The PGT 216 may distribute the approved predicate 212 to the identified managed devices 106.

In some embodiments, responsive to the edits, PGT 216 may collect the analytics data 222. The analytics data 222 that is collected may be related to the edited predicate such as discrepancies between the edited predicate and the returned predicate 204. The PGT 216 may analyze discrepancies or the changes to the returned predicate 204 and modify the custom AI model 218 may be modified based on the analyzed discrepancies. The custom AI model 218 may be modified to change a future predicate that is returned based on the NL input 206.

Additionally, the PGT 216 may periodically modify the custom AI model 218 not in response to rejected or edited predicates. For instance, the PGT 216 may modify the custom AI model 218 with updated supported attributes. For instance, the third-party system 124 may update the DDM documentation 118, which may include a new DDM status, a new DDM key, other updated supported attributes, or combinations thereof. The custom AI model 218 may be modified based on the updates. For instance, each time the supported attributes are updated, or new supported attributes are added, the custom AI model 218 may be modified.

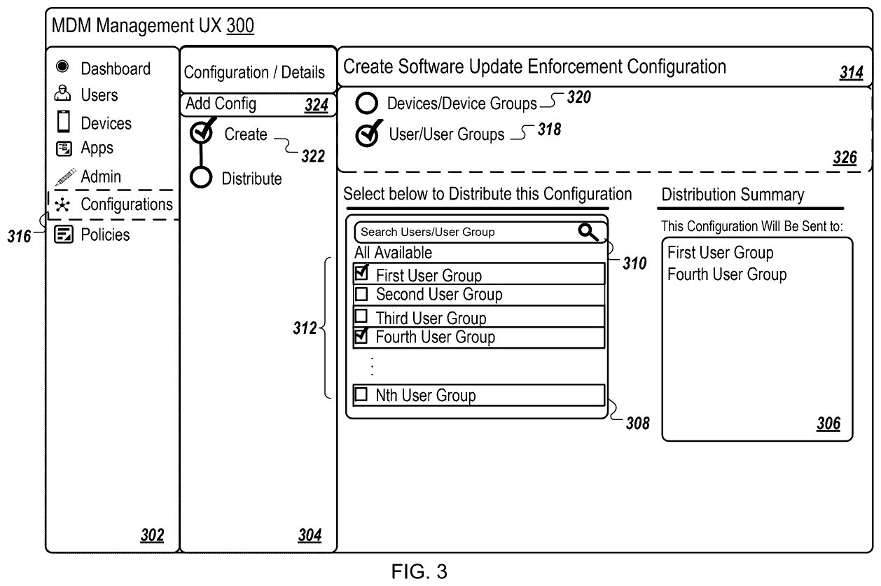

FIG. 3 is a block diagram of an example MDM admin UX 300 that may be implemented in the process 200 of FIG. 2. Generally, the MDM admin UX 300 may be configured to implement and change MDM configurations at managed devices of a managed network such as the managed devices 106 of the managed network 110. In the process 200 of FIG. 2, the MDM admin UX 300 may be implemented to identify one or more managed devices to which the predicate is distributed. The MDM admin UX 300 may be hosted by an appserver and accessible via a browser application such as the appsense 116 and the browser app 117 of FIGS. 1 and 2.

For instance, in the depicted embodiment, the MDM admin UX 300 may include a first portion 302. The first portion 302 enables selection of one or more functions of an MDM service. In these and other embodiments, the first portion 302 includes a configuration tab, which is generally indicated by dashed box 316. Selection of the configuration tab 316 opens an add config. window 324, which enables an administrator to generate a predicate using a PGT such as the PGT 216 of FIG. 2 and identifies one or more managed devices to which the predicate is distributed.

In the depicted embodiment, selection of the configuration tab 316 may open a configuration creation window 314. The configuration creation window 314 includes an identification-type window 326 in which a first option 320 and a second option 318 are provided. Selection of the first option 320 enables identification of managed devices by “devices or device group.” Selection of the second option 318 enables identification of managed devices by “users or user groups.” In FIG. 3, a check in the circle next to the second option 318 “User/User Groups” indicates that the identification of the managed devices is performed based on the user and user groups. In other circumstances, the first option 320 may be selected, which indicates that the identification of the managed devices is performed based on the device or device groups.

After the identification type is selected, an identification window 308 may be provided. The identification window 308 lists user groups and users 312 that may be identified for distribution of the predicate. Additionally, the identification window 308 includes a search bar 310, which may enable and administrator to type or otherwise enter data to find a user or user group in the identification window 308. After one or more of the user groups and users 312 are selected (as indicated by a check in the box next to the group), the managed devices in the corresponding group are identified to receive the predicate. Additionally, in the MDM admin UX 300 may include a distribution summary window 306 that lists the identified user groups.

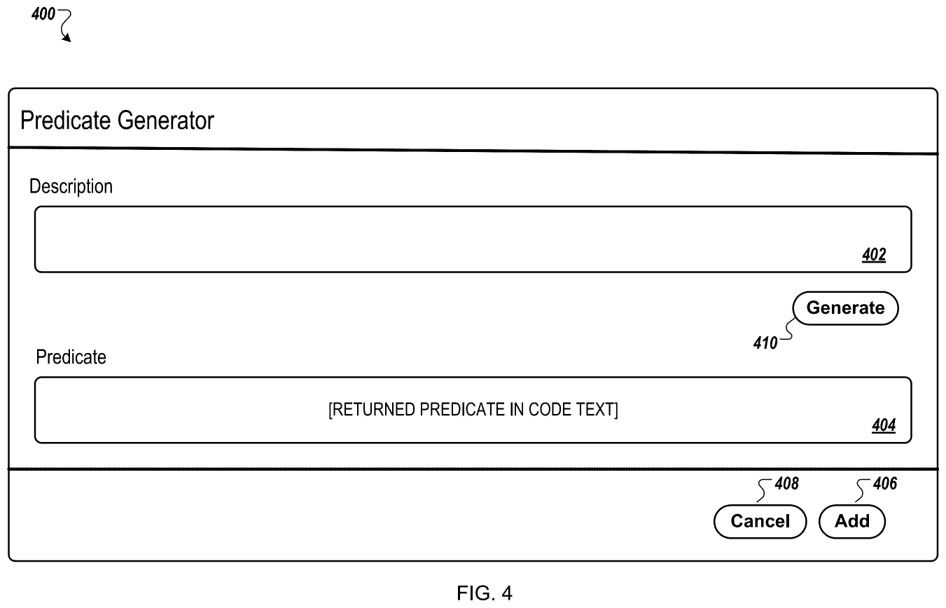

FIG. 4 is a block diagram of an example predicate UX 400 that may be implemented in the process 200 of FIG. 2. The predicate UX 400 may be configured to receive user inputs (e.g., the NL input 206 of FIG. 2) and to display returned predicates (e.g., the returned predicate 204 of FIG. 2). Additionally, the predicate UX 400 may be configured to communicate feedback data (e.g., the feedback data 202 of FIG. 2) responsive to input from an administrator. The predicate UX 400 may be displayed or caused to be displayed at an admin management device such as the admin management device 114 of FIGS. 1 and 2. For instance, the predicate UX 400 may be presented to an administrator during generation and distribution of predicates according to the process 200 of FIG. 2. The predicate UX 400 may be hosted by an appserver and accessible via a browser application such as the appsense 116 and the browser app 117 of FIGS. 1 and 2.

The predicate UX 400 may include an activation field 402. The activation field 402 is configured to receive written text, such as text entered using a keyboard or another suitable user interface device. The activation field 402 may accept natural language text, code fragments, operators, etc. In some instances, the activation field 402 may be connected to another user input device such as a microphone, which enables entry of audio input that may be translated to text or processed as an audio file.

The predicate UX 400 may include a generate button 410. The generate button 410 initiates transfer of the data in the activation field 402 to a custom AI model such as the custom AI model 218. The generate button 410 may be selected by the administrator after the data is entered into the activation field.

predicate UX 400 may include a second field 404. The second field 404 may display or present information returned from a PGT such as the PGT 216. In some embodiments, the user input entered into the activation field 402 may not be properly associated with a predicate. Accordingly, an error message may be presented in the second field 404. An example of the error message may include “The requested information is not available in the retrieved data. Please try another query or topic.” or another error message that prompts the administrator to provide modified user input into the activation field.

Additionally, a returned predicate may be displayed in the second field 404. The returned predicate may be presented in text code, which may enable inspection and review of the returned predicate. After the returned predicate is displayed in the second field, the returned predicate may be rejected, confirmed, or edited. To reject the returned predicate, an administrator may select a cancel button 408. Rejection of the returned predicate may prevent the returned predicate from being distributed to managed devices and may prompt a modification to the custom AI model. To approve the returned predicate, the administrator may select an add button 406. Selection of the add button 406 may trigger distribution of the returned predicate to one or more managed devices by the PGT. To edit the returned predicate, the administrator may type or otherwise input to the second field. For instance, the administrator may click on the displayed, returned predicate and add code segments, remove code segments, rearrange the returned predicate, or other edit the returned predicate. Edits entered into the second field 404 generates an edited predicate. The administrator may then select the add button 406 to distribute the edited predicate to one or more managed devices.

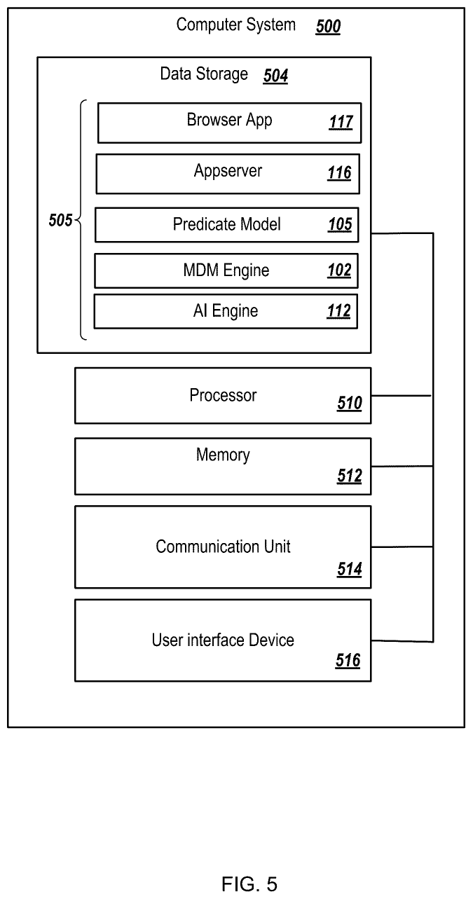

FIG. 5 illustrates an example computer system 500 configured AI-based predicate generation in a managed network, according to at least one embodiment of the present disclosure. The computer system 500 may be implemented in the operating environment 100 of FIG. 1 or another suitable operating environment. Examples of the computer system 500 may include the remote management device 104, the third-party system 124, the managed device 106, the admin management device 114, or some combination thereof. The computer system 500 may include one or more processors 510, a memory 512, a communication unit 514, a user interface device 516, and a data storage 504 that includes the predicate model 105, the MDM engine 102, the browser app 117, the appserver 116, and the AI engine 112 (collectively, modules 505).

The processor 510 may include any suitable special-purpose or general-purpose computer, computing entity, or processing device including various computer hardware or software modules and may be configured to execute instructions stored on any applicable computer-readable storage media. For example, the processor 510 may include a microprocessor, a microcontroller, a digital signal processor (DSP), an ASIC, an FPGA, or any other digital or analog circuitry configured to interpret and/or to execute program instructions and/or to process data. Although illustrated as a single processor in FIG. 5, the processor 510 may more generally include any number of processors configured to perform individually or collectively any number of operations described in the present disclosure. Additionally, one or more of the processors 510 may be present on one or more different electronic devices or computing systems. In some embodiments, the processor 510 may interpret and/or execute program instructions and/or process data stored in the memory 512, the data storage 504, or the memory 512 and the data storage 504. In some embodiments, the processor 510 may fetch program instructions from the data storage 504 and load the program instructions in the memory 512. After the program instructions are loaded into the memory 512, the processor 510 may execute the program instructions.

The memory 512 and the data storage 504 may include computer-readable storage media for carrying or having computer-executable instructions or data structures stored thereon. Such computer-readable storage media may include any available media that may be accessed by a general-purpose or special-purpose computer, such as the processor 510. By way of example, and not limitation, such computer-readable storage media may include tangible or non-transitory computer-readable storage media including RAM, ROM, EEPROM, CD-ROM or other optical disk storage, magnetic disk storage or other magnetic storage devices, flash memory devices (e.g., solid state memory devices), or any other storage medium which may be used to carry or store desired program code in the form of computer-executable instructions or data structures and that may be accessed by a general-purpose or special-purpose computer. Combinations of the above may also be included within the scope of computer-readable storage media. Computer-executable instructions may include, for example, instructions and data configured to cause the processor 510 to perform a certain operation or group of operations.

The communication unit 514 may include one or more pieces of hardware configured to receive and send communications. In some embodiments, the communication unit 514 may include one or more of an antenna, a wired port, and modulation/demodulation hardware, among other communication hardware devices. In particular, the communication unit 514 may be configured to receive a communication from outside the computer system 500 and to present the communication to the processor 510 or to send a communication from the processor 510 to another device or network (e.g., the network 120 of FIG. 1).

The user interface device 516 may include one or more pieces of hardware configured to receive input from and/or provide output to a user. In some embodiments, the user interface device 516 may include one or more of a speaker, a microphone, a display, a keyboard, a touch screen, or a holographic projection, among other hardware devices.

The modules 505 may include program instructions stored in the data storage 504. The processor 510 may be configured to load the modules 505 into the memory 512 and execute the modules 505. Alternatively, the processor 510 may execute the modules 505 line-by-line from the data storage 504 without loading them into the memory 512. When executing the modules 505, the processor 510 may be configured to perform one or more processes or operations described elsewhere in this disclosure.

Modifications, additions, or omissions may be made to the computer system 500 without departing from the scope of the present disclosure. For example, in some embodiments, the computer system 500 may not include the user interface device 516. In some embodiments, the different components of the computer system 500 may be physically separate and may be communicatively coupled via any suitable mechanism. For example, the data storage 504 may be part of a storage device that is separate from a device, which includes the processor 510, the memory 512, and the communication unit 514, that is communicatively coupled to the storage device. The embodiments described herein may include the use of a special-purpose or general-purpose computer including various computer hardware or software modules, as discussed in greater detail below.

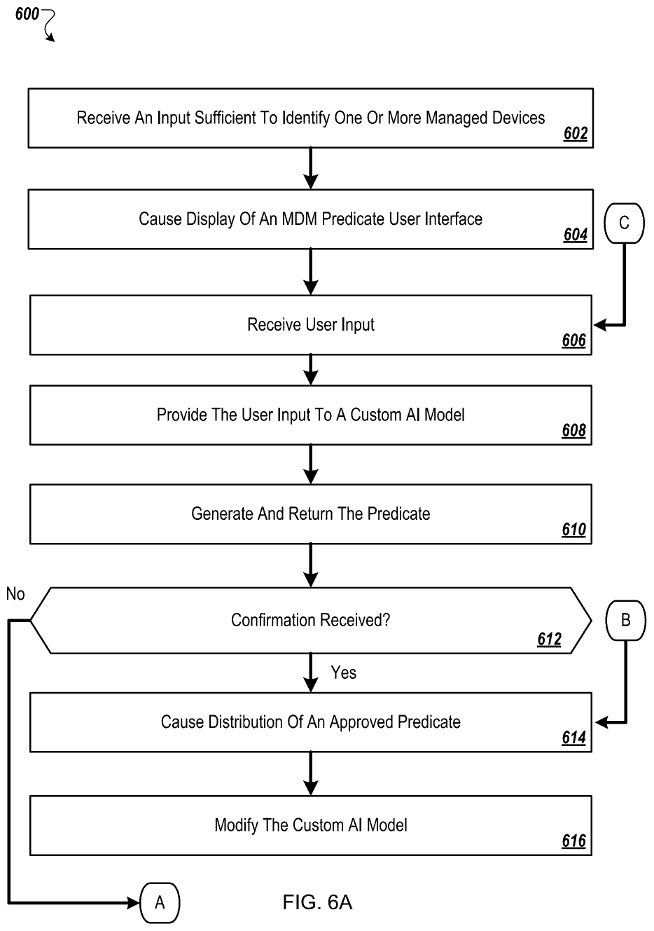

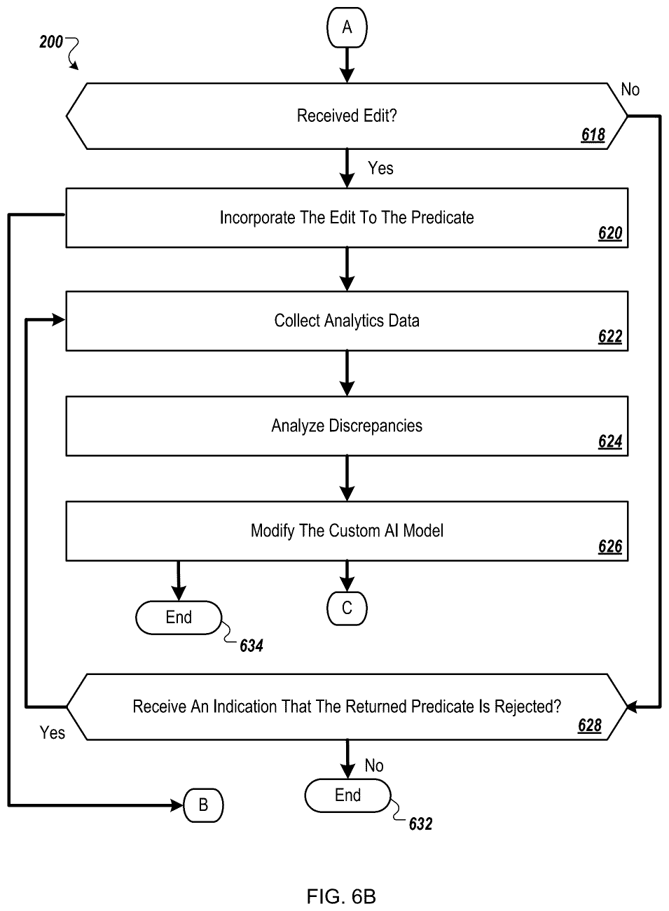

FIGS. 6A and 6B are a flow chart of an example method 600 of AI-based predicate generation according to at least one embodiment of the present disclosure. The method 600 may be performed by a PGT, such as the PGT 216 described elsewhere in the present disclosure. The method 600 may be implemented in an MDM network that implements DDM. Referring to FIG. 6A, the method 600 may begin at block 602 in which an input sufficient to identify one or more managed devices of the MDM network may be received. For example, in the MDM network, an MDM admin UX may provide visibility to managed devices of an MDM network and configurations thereof. The MDM admin UX may enable an administrator to select one or more of the devices enrolled in the MDM network. In some embodiments, individual devices may be selected. In some embodiments groups of devices may be selected based on a common feature, common role of associated users, environment conditions, associated entity, etc. In some embodiments, the managed devices include Apple™ devices or may include devices implementing one or more Apple products or operating systems.

At block 604, display of a predicate UX may be caused. For instance, in the example above, an administrator may select the one or more devices and wish to change or install a configuration at the selected devices. The MDM admin UX may provide a button that, when selected, triggers the display of the predicate UX. The predicate UX may include an activation field.

At block 606, user input may be received. The user input may be received in the activation field. The user input describes a desired MDM configuration to be implemented at the identified managed devices. The user input may include a natural language description, which may further include an operator, a code fragment, as well as natural language text or audio input. Additionally, the natural language description may include a mistake such as a misspelled word, a typographical error, or grammatical error.

At block 608, the user input may be provided to a custom AI model. The custom AI model is trained on supported attributes of a DDM system. Some examples of the supported attributes include predicate language and syntax, DDM statuses, DDM status objects, DDM status object syntax, declarations, DDM keys, sample predicates, sample user inputs, other supported attributes, or combinations thereof. The custom AI model may be configured to broadly interpret the natural language description to associate the natural language of the user input with a predicate that best reflects the desired MDM configuration and that includes parameters of the identified managed devices. The custom AI model may be further configured to return an error message if no predicate reflecting the desired MDM configuration and the parameters of the identified managed devices is found. The custom AI model may also be configured to broadly interpret the operator or the code fragment and to correct the mistake prior to the association between the natural language of the user input and the predicate.

At block 610, the predicate may be generated and returned. The predicate that is returns implements the desired MDM configuration described in the activation field at the identified managed devices. The predicate may be formatted according to Cocoa™. The predicate may be returned in a second field of the predicate UX, in code text.

At block 612, it may be determined whether a confirmation is received. In some embodiments, the confirmation may be received at the predicate UX. In response to receipt of the confirmation (“Yes” at block 612), the method 600 may proceed to block 614. In response to not receiving of the confirmation (“No” at block 612), the method 600 may proceed to block 618 of FIG. 6B.

At block 614, the approved predicate may be distributed. For example, the approved predicate may be distributed to the identified managed devices. The approved predicate includes the returned predicate displayed in the predicate UX when the confirmation input is received.

At block 616, the custom AI model may be modified. The custom AI model may be modified with updated supported attributes that include a new DDM status, a new DDM key, other updated supported attributes, or combinations thereof. The operations of block 616 may occur multiple times. For instance, each time the supported attributes are updated or new supported attributes are added, the operations of block 616 may occur.

At block 618 of FIG. 6B, it may be determined whether an edit to the code text is received. For example, the returned predicate may be displayed as code text in the second field. The edit may be received in the second field. In response to receipt of the edit (“Yes” at block 618), the method 600 may proceed to block 620. In response to not receiving the edit (“Yes” at block 618), the method 600 may proceed to block 628.

At block 620, the edit may be incorporated into the returned predicate to generate an edited predicate. From block 620, the method 600 may proceed to block 614 from block 620. In these circumstances, the approved predicate includes the edited predicate. Accordingly, the edited predicate may be distributed to the identified managed devices.

The method 600 may also proceed to block 622 from block 620. At block 622, analytics data may be collected. The analytics data that is collected may be related to the edited predicate such as discrepancies between the edited predicate and the returned predicate. At block 624, the discrepancies or the changes to the returned predicate may be analyzed. At block 626, the custom AI model may be modified. The AI model may be modified to change a future predicate that is returned based on user input. The method 600 may end (represented by block 634) or may restart at block 602.

At block 628, it may be determined whether an indication that the returned predicate is rejected has been received. The indication may be received in the service predicate UX in some embodiments. In response to not receiving the indication (“No” at block 628), the method 600 may continue to block 632. In response to the indication (“Yes” at block 628), the method 600 may continue to block 622. From block 622, the method 600 may proceed to block 624 in which analytics data may be collected. The analytics collected at block 624 may be related to the rejected, returned predicate. For instance, the analytics that are collected may be related to the user input, the operations of the custom AI model and the returned predicate. The method 600 may proceed to block 626, in which the custom AI model may be modified. The custom AI model may be modified to change a future predicate returned based on user input. The method 600 may proceed to blocks 606 in which modified user input may be received in the activation field. The modified user input may describe a modified desired MDM configuration or another attempt to describe the previously desired MDM configuration. From block 606, the method 600 may proceed through one or more of blocks 608, 610, 612, 614, 616, 618, 620, 622, 624, 626, 628, or some combination thereof in which the modified user input is provided to the custom AI model, a modified predicate is returned that implements the modified desired MDM configuration described in the activation field at the identified managed devices and the approved predicate includes the modified predicate.

Although illustrated as discrete blocks, one or more blocks in FIGS. 6A and 6B may be divided into additional blocks, combined into fewer blocks, or eliminated, depending on the desired implementation. One or more of the methods described in the present disclosure may be performed in a suitable operating environment such as the operating environment 100. The method 600 may be performed by the remote management device 104 or another computing device (e.g., 500 of FIG. 5). In some embodiments, the remote management device 104 or another computing system may include or may be communicatively coupled to a non-transitory computer-readable medium (e.g., the memory 512 of FIG. 5) having stored thereon programming code or instructions that are executable by one or more processors (such as the processor 510 of FIG. 5) to cause a computing system or the remote management device 104 to perform or control performance of the method 600. Additionally or alternatively, the remote management device 104 or another computing device may include the processor 510 described elsewhere in this disclosure that is configured to execute computer instructions to cause the remote management device 104 or another computing systems to perform or control performance of the methods.

Further, modifications, additions, or omissions may be made to the methods without departing from the scope of the present disclosure. For example, the operations of methods may be implemented in differing orders. Furthermore, the outlined operations and actions are only provided as examples, and some of the operations and actions may be optional, combined into fewer operations and actions, or expanded into additional operations and actions without detracting from the disclosed embodiments.

The embodiments described herein may include the use of a special purpose or general-purpose computer including various computer hardware or software modules, as discussed in greater detail below.

Embodiments described herein may be implemented using computer-readable media for carrying or having computer-executable instructions or data structures stored thereon. Such computer-readable media may be any available media that may be accessed by a general purpose or special purpose computer. By way of example, and not limitation, such computer-readable media may include non-transitory computer-readable storage media including Random Access Memory (RAM), Read-Only Memory (ROM), Electrically Erasable Programmable Read-Only Memory (EEPROM), Compact Disc Read-Only Memory (CD-ROM) or other optical disk storage, magnetic disk storage or other magnetic storage devices, flash memory devices (e.g., solid state memory devices), or any other storage medium which may be used to carry or store desired program code in the form of computer-executable instructions or data structures and which may be accessed by a general purpose or special purpose computer. Combinations of the above may also be included within the scope of computer-readable media.

Computer-executable instructions may include, for example, instructions and data, which cause a general-purpose computer, special purpose computer, or special purpose processing device (e.g., one or more processors) to perform a certain function or group of functions. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

As used herein, the terms “module” or “component” may refer to specific hardware implementations configured to perform the operations of the module or component and/or software objects or software routines that may be stored on and/or executed by general purpose hardware (e.g., computer-readable media, processing devices, etc.) of the computing system. In some embodiments, the different components, modules, engines, and services described herein may be implemented as objects or processes that execute on the computing system (e.g., as separate threads). While some of the system and methods described herein are generally described as being implemented in software (stored on and/or executed by general purpose hardware), specific hardware implementations or a combination of software and specific hardware implementations are also possible and contemplated. In this description, a “computing entity” may be any computing system as previously defined herein, or any module or combination of modulates running on a computing system.

The various features illustrated in the drawings may not be drawn to scale. The illustrations presented in the present disclosure are not meant to be actual views of any particular apparatus (e.g., device, system, etc.) or method, but are representations employed to describe embodiments of the disclosure. Accordingly, the dimensions of the features may be expanded or reduced for clarity. In addition, some of the drawings may be simplified for clarity. Thus, the drawings may not depict all of the components of a given apparatus (e.g., device) or all operations of a particular method.

Terms used in the present disclosure and the claims (e.g., bodies of the appended claims) are intended as “open” terms (e.g., the term “including” should be interpreted as “including, but not limited to,” the term “having” should be interpreted as “having at least,” the term “includes” should be interpreted as “includes, but is not limited to,” among others). Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations.

In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in instances in which a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc. Further, any disjunctive word or phrase presenting two or more alternative terms should be understood to contemplate the possibilities of including one of the terms, either of the terms, or both terms. For example, the phrase “A or B” should be understood to include the possibilities of “A” or “B” or “A and B.”However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

The terms “first,” “second,” “third,” etc., are not necessarily used to connote a specific order or number of elements. Generally, the terms “first,” “second,” “third,” etc., are used to distinguish between different elements as generic identifiers. Absence a showing that the terms “first,” “second,” “third,” etc., connote a specific order, these terms should not be understood to connote a specific order. Furthermore, absence a showing that the terms “first,” “second,” “third,” etc., connote a specific number of elements, these terms should not be understood to connote a specific number of elements. For example, a first widget may be described as having a first side and a second widget may be described as having a second side. The use of the term “second side” with respect to the second widget may be to distinguish such side of the second widget from the “first side” of the first widget and not to connote that the second widget has two sides.

All examples and conditional language recited herein are intended for pedagogical objects to aid the reader in understanding the invention and the concepts contributed by the inventor to furthering the art and are to be construed as being without limitation to such specifically recited examples and conditions. Although embodiments of the present inventions have been described in detail, it should be understood that the various changes, substitutions, and alterations could be made hereto without departing from the scope of the invention.

What is claimed is:

1. A method of artificial intelligence (AI)-based predicate generation in a mobile device management (MDM) network implementing declarative device management (DDM), the method comprising:
receiving an input sufficient to identify one or more managed devices of the MDM network;
causing display of an MDM predicate user interface that includes an activation field;
receiving, in the activation field, user input that describes a desired MDM configuration at the identified managed devices, wherein the user input includes a natural language description;
providing the user input to a custom AI model, wherein:
the AI model is trained on supported attributes of a DDM system, the supported attributes including predicate language and syntax, DDM statuses, DDM status objects, DDM status object syntax, declarations, and DDM keys, and
the custom AI model is configured to broadly interpret the natural language description to associate the natural language of the user input with a predicate that best reflects the desired MDM configuration and parameters of the identified managed devices;
generating and returning the predicate that implements the desired MDM configuration at the identified managed devices as described in the activation field; and
causing distribution of an approved predicate to the identified managed devices.

2. The method of claim 1, further comprising receiving a confirmation input at the MDM predicate user interface, wherein the approved predicate includes the returned predicate displayed in the MDM predicate user interface when the confirmation input is received.

3. The method of claim 1, further comprising modifying the custom AI model with updated supported attributes that include a new DDM status or a new DDM key.

4. The method of claim 1, wherein:
the predicate is returned in a second field of the MDM predicate user interface; and
predicate is returned in the second field in code text.

5. The method of claim 4, further comprising:
receiving an edit to the code text in the second field to generate an edited predicate; and
responsive to receipt of the edit, incorporating the edit to the predicate, wherein the approved predicate includes the edited predicate; and
responsive to receipt of the edit:
collecting analytics data related to the edited predicate;
analyzing discrepancies between the edited predicate and the returned predicate; and
based on the analyzed discrepancies, modifying the custom AI model to change a future predicate that is returned based on user input.

6. The method of claim 1, further comprising:
receiving an indication that the returned predicate is rejected in the MDM predicate user interface;
collecting analytics data related to the rejected, returned predicate;
modifying the custom AI model to change a future predicate returned based on user input;
receiving, in the activation field, modified user input that describes a modified desired MDM configuration,
providing the modified user input to the custom AI model; and
returning a modified predicate that implements the modified desired MDM configuration described in the activation field at the identified managed devices,
wherein, the approved predicate includes the modified predicate.

7. The method of claim 1, wherein the custom AI model is further configured to return an error message responsive to no predicate reflecting the desired MDM configuration and the parameters of the identified managed devices.

8. The method of claim 1, wherein:
the user input includes an operator or a code fragment; and
the custom AI model is further configured to broadly interpret the operator or the code fragment.

9. The method of claim 1, wherein:
the user input includes a mistake including a misspelled word, a typographical error, or grammatical error; and
the custom AI model is further configured to correct the mistake prior to the association between the natural language of the user input and the predicate.

10. The method of claim 1, wherein:
the one or more managed devices include Apple™ devices; and
the predicate is formatted according to Cocoa™.

11. A non-transitory computer-readable medium having encoded therein programming code executable by one or more processors to perform or control performance of operations of artificial intelligence (AI)-based predicate generation in a mobile device management (MDM) network implementing declarative device management (DDM), the operations comprising:
receiving an input sufficient to identify one or more managed devices of the MDM network;
causing display of an MDM predicate user interface that includes an activation field;
receiving, in the activation field, user input that describes a desired MDM configuration at the identified managed devices, wherein the user input includes a natural language description;
providing the user input to a custom AI model, wherein:
the AI model is trained on supported attributes of a DDM system, the supported attributes including predicate language and syntax, DDM statuses, DDM status objects, DDM status object syntax, declarations, and DDM keys, and
the custom AI model is configured to broadly interpret the natural language description to associate the natural language of the user input with a predicate that best reflects the desired MDM configuration and parameters of the identified managed devices;
generating and returning the predicate that implements the desired MDM configuration at the identified managed devices as described in the activation field; and
causing distribution of an approved predicate to the identified managed devices.

12. The method of claim 11, further comprising receiving a confirmation input at the MDM predicate user interface, wherein the approved predicate includes the returned predicate displayed in the MDM predicate user interface when the confirmation input is received.

13. The method of claim 11, further comprising modifying the custom AI model with updated supported attributes that include a new DDM status or a new DDM key.

14. The method of claim 11, wherein:
the predicate is returned in a second field of the MDM predicate user interface; and
predicate is returned in the second field in code text.

15. The method of claim 14, further comprising:
receiving an edit to the code text in the second field to generate an edited predicate; and
responsive to receipt of the edit, incorporating the edit to the predicate, wherein the approved predicate includes the edited predicate; and
responsive to receipt of the edit:
collecting analytics data related to the edited predicate;
analyzing discrepancies between the edited predicate and the returned predicate; and
based on the analyzed discrepancies, modifying the custom AI model to change a future predicate that is returned based on user input.

16. The method of claim 11, further comprising:
receiving an indication that the returned predicate is rejected in the MDM predicate user interface;
collecting analytics data related to the rejected, returned predicate;
modifying the custom AI model to change a future predicate returned based on user input;
receiving, in the activation field, modified user input that describes a modified desired MDM configuration,
providing the modified user input to the custom AI model; and
returning a modified predicate that implements the modified desired MDM configuration described in the activation field at the identified managed devices,
wherein, the approved predicate includes the modified predicate.

17. The method of claim 11, wherein the custom AI model is further configured to return an error message responsive to no predicate reflecting the desired MDM configuration and the parameters of the identified managed devices.

18. The method of claim 11, wherein:
the user input includes an operator or a code fragment; and
the custom AI model is further configured to broadly interpret the operator or the code fragment.

19. The method of claim 11, wherein:
the user input includes a mistake including a misspelled word, a typographical error, or grammatical error; and
the custom AI model is further configured to correct the mistake prior to the association between the natural language of the user input and the predicate.

20. The method of claim 11, wherein:
the one or more managed devices include Apple™ devices; and
the predicate is formatted according to Cocoa™.
